(19) United States
(12) Patent Application Publication
(10) Pub. No.: US 2015/0019271 A1
(43) Pub. Date: Jan. 15, 2015

(54) ESTIMATING WAIT TIME FOR AN ESTABLISHMENT

(71) Applicant: International Business Machines Corporation, Armonk, NY (US)

(72) Inventors: Kelly Abuelsaad, Somers, NY (US); Lisa Seacat DeLuca, Baltimore, MD (US); Soobaek Jang, Hamden, CT (US); Daniel C. Krook, Fairfield, CT (US)

(21) Appl. No.: 13/939,543

(22) Filed: Jul. 11, 2013

(51) Int. Cl. G06Q 50/12; G06Q 50/00; G06Q 10/02

(52) U.S. Cl. CPC G06Q 50/12; G06Q 10/02; G06Q 50/01
USPC 705/5

(57) ABSTRACT

A computer collects resource reservation history for a resource for a plurality of reservation time blocks. The computer collects resource reservation wait time history for the resource for each reservation time block. The computer determines a number of patrons that utilized the resource during each reservation time block and creates a resource reservation wait time model. The computer receives a request for a resource reservation wait time estimate for a first reservation time block and collects a first plurality of social media content. The computer determines an estimated number of patrons that intend to utilize the resource during the first reservation time block based on at least the first plurality of social media content. The computer determines a first estimated wait time for the first reservation time block by comparing at least the estimated number of patrons to the resource reservation wait time model.

### FIELD OF THE INVENTION

The present invention relates generally to social media, and more particularly to a predicting wait time for an establishment based on information gathered from social media and other resources.

### BACKGROUND

Restaurant wait times have existed nearly as long as restaurants themselves. In the case where a restaurant does not accept or require reservations, wait times can often be quite unpredictable. This makes gathering a group of people to head to a restaurant for the night a daunting and sometimes frustrating task. Recently, with the progress of mobile and social media applications, solutions for mitigating and determining restaurant wait time have begun to emerge. The majority of mobile and social media applications that deal with restaurant wait time address real-time situations where a user is given current wait time information for a restaurant. However, this is not helpful for those who desire to know what a restaurant wait time is projected to be at a future time or on a future date.

### SUMMARY

Embodiments of the present invention provide a system, method, and program product for a determining a resource reservation wait time. A first computer collects resource reservation history for a first resource for a plurality of reservation time blocks. The first computer collects resource reservation wait time history for the first resource for each reservation time block of the plurality of reservation time blocks. The first computer determines a number of patrons that utilized the first resource during each reservation time block of the plurality of reservation time blocks based on one or more of the resource reservation wait time history and the resource reservation history for the first resource. The first computer creates a first resource reservation wait time model by correlating the number of patrons that utilized the first resource with the resource reservation wait time history for the first resource collected for the plurality of reservation time blocks. The first computer receives a request for a first resource reservation wait time estimate for a first reservation time block from a first user. The first computer collects a first plurality of social media content, wherein each member of the first plurality of social media content includes information indicating an intent to utilize the first resource during the first reservation time block. The first computer determines an estimated number of patrons that intend to utilize the first resource during the first reservation time block based on at least the first plurality of social media content. The first computer determines a first estimated wait time for the first reservation time block by comparing at least the estimated number of patrons that intend to utilize the first resource during the first reservation time block to the first resource reservation wait time model.

### BRIEF DESCRIPTION OF THE SEVERAL VIEWS OF THE DRAWINGS

FIG. 1 illustrates a wait time estimation system, in accordance with an embodiment of the invention.

FIGS. 2 and 3 is a flowchart illustrating the operations of the wait time program of FIG. 1 in determining an estimated wait time for an establishment, in accordance with an embodiment of the invention.

FIG. 4 is a block diagram depicting the hardware components of wait time estimation system of FIG. 1, in accordance with an embodiment of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Embodiments of the present invention will now be described in detail with reference to the accompanying Figures.

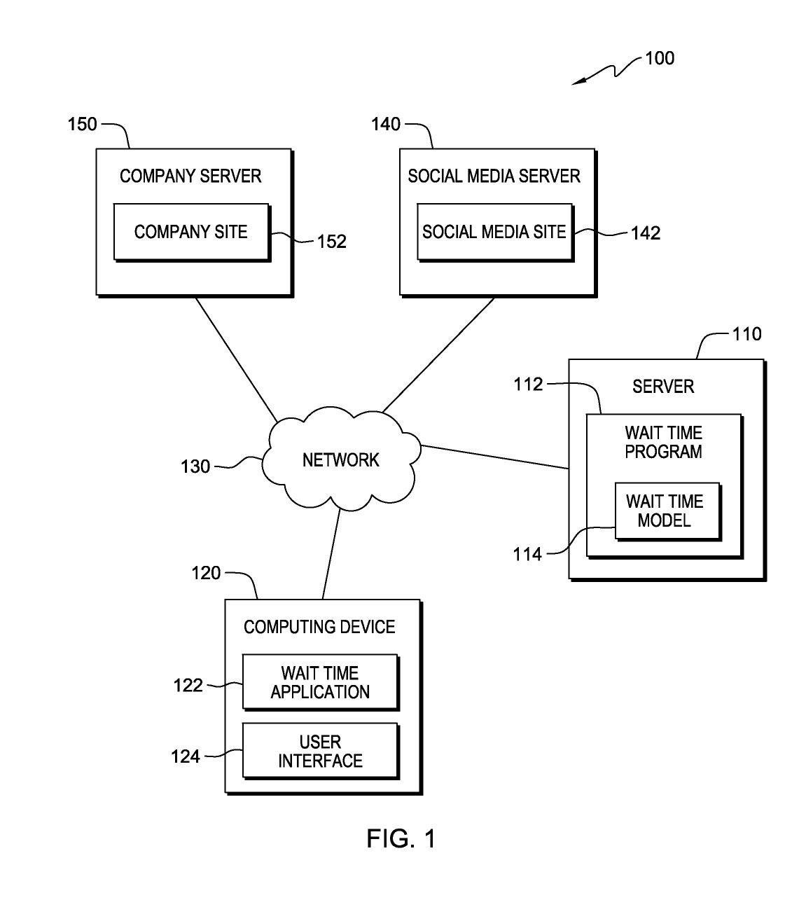

FIG. 1 illustrates wait time estimation system 100, in accordance with an embodiment of the invention. In an exemplary embodiment, wait time estimation system 100 includes server 110, computing device 120, social media server 140 and company server 150 all interconnected via network 130.

In the exemplary embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between server 110, computing device 120, company server 150 and social media server 140.

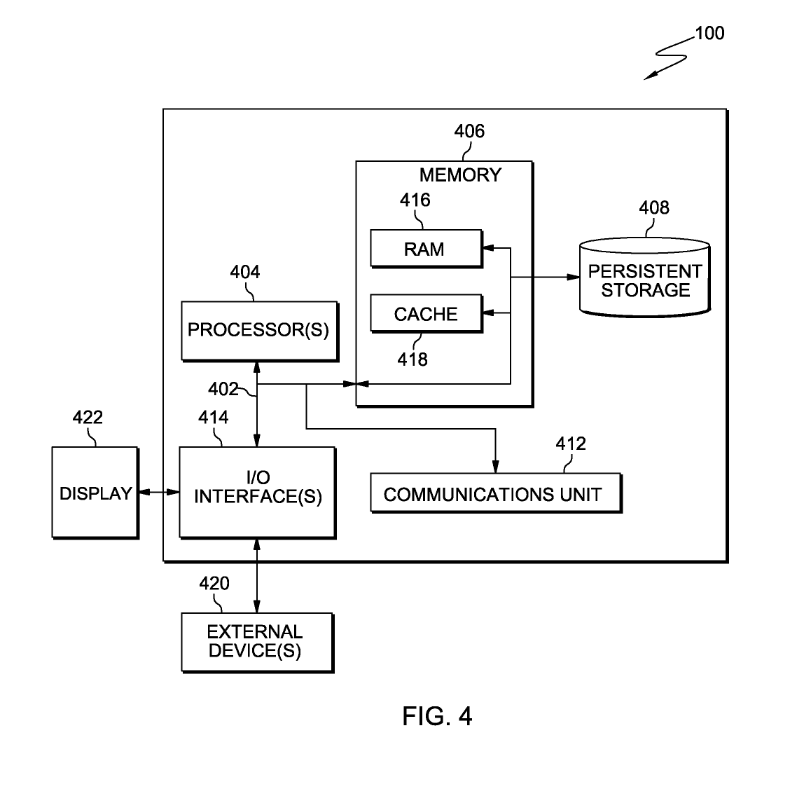

Social media server 140 includes social media site 142. Social media server 140 may be a desktop computer, a notebook, a laptop computer, a tablet computer, a handheld device, a smart-phone, a thin client, or any other electronic device or computing system capable of receiving and sending data to and from other computing devices such as computing device 120, company server 150 and server 110 via network 130. Although not shown, optionally, social media server 140 can comprise a cluster of web servers executing the same software to collectively process the requests for the web pages as distributed by a front end server and a load balancer. In an exemplary embodiment, social media server 140 is a computing device that is optimized for the support of websites, which reside on social media server 140, such as social media site 142, and for the support of network requests related to websites, which reside on social media server 140. Social media server 140 is described in more detail with reference to FIG. 4.

Social media site 142 is a collection of files including, for example, HTML files, CSS files, image files and JavaScript files. Social media site 142 can also include other resources such as audio files and video files. In an exemplary embodiment, social media site 142 is a social media website such as Facebook™, Twitter™, Linkedin™, or Myspace™.

Company server 150 includes company site 152. Company server 150 may be a desktop computer, a notebook, a laptop computer, a tablet computer, a handheld device, a smart-phone, a thin client, or any other electronic device or computing system capable of receiving and sending data to and from other computing devices such as computing device 120, social media server 140, and server 110 via network 130. Although not shown, optionally, company server 150 can comprise a cluster of web servers executing the same software to collectively process the requests for the web pages as distributed by a front end server and a load balancer. In an exemplary embodiment, company server 150 is a computing device that is optimized for the support of websites which reside on company server 150, such as company site 152, and for the support of network requests related to websites, which reside on company server 150. Company server 150 is described in more detail with reference to FIG. 4.

Company site 152 is a collection of files including, for example, HTML files, CSS files, image files and JavaScript files. Company site 152 can also include other resources such as audio files and video files. In an exemplary embodiment, company site 152 is a website for a company such as a restaurant, night club or similar establishment.

Computing device 120 includes wait time application 122 and user interface 124. Computing device 120 may be a desktop computer, a notebook, a laptop computer, a tablet computer, a handheld device, a smart-phone, a thin client, or any other electronic device or computing system capable of receiving and sending data to and from server 110, company server 150 and social media server 140 via network 130. Computing device 120 is described in more detail with reference to FIG. 4.

User interface 124 includes components used to receive input from a user and transmit the input to an application residing on computing device 120. In an exemplary embodiment, user interface 124 uses a combination of technologies and devices, such as device drivers, to provide a platform to enable users of computing device 120 to interact with wait time application 122. In the exemplary embodiment, user interface 124 receives input, such as textual input received from a physical input device, such as a keyboard, via a device driver that corresponds to the physical input device.

Wait time application 122 is a software application capable of receiving inputted information from a user of computing device 120 via user interface 124 and transmitting the inputted information to another computing device, such as server 110, company server 150 or social media server 140, via network 130.

Server 110 includes wait time program 112. Server 110 may be a desktop computer, a notebook, a laptop computer, a tablet computer, a handheld device, a smart-phone, a thin client, or any other electronic device or computing system capable of receiving and sending data to and from computing device 120, company server 150 and social media server 140 via network 130. Server 110 is described in more detail with reference to FIG. 4.

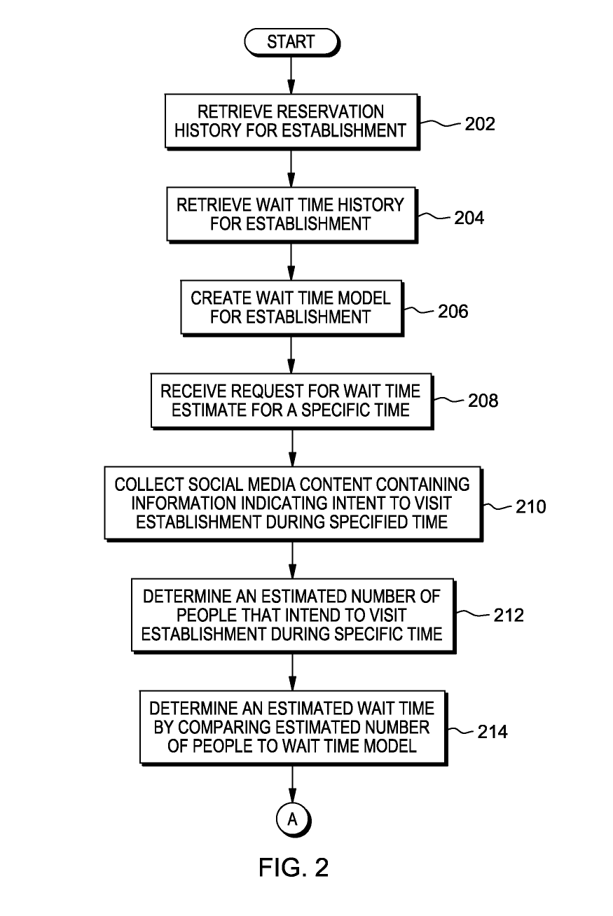

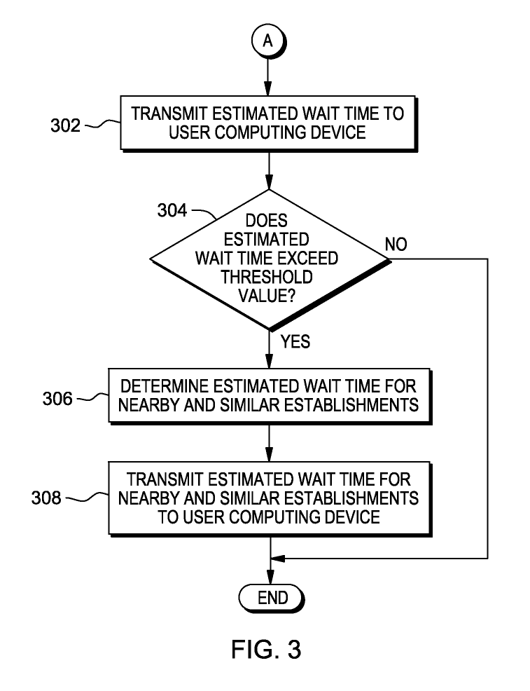

Wait time program 112 includes wait time model 114. In the exemplary embodiment, wait time program 112 includes components to analyze social media content and any other content received from social media server 140 and company server 150 via network 130 and determine an estimated wait time for an establishment, such as a restaurant, bar, or night club. The operation of wait time program 112 is described in further detail below with reference to FIGS. 2 and 3.

In the exemplary embodiment, wait time model 114 is a model dataset used by wait time program 112 for comparison analysis in determining an estimated wait time for an establishment. Wait time model 114 is described in further detail with reference to FIG. 2.

FIGS. 2 and 3 are a flowchart illustrating the operations of wait time program 112 in determining an estimated wait time for an establishment, in accordance with an exemplary embodiment of the invention. In an exemplary embodiment, wait time program 112 retrieves reservation history for an establishment, such as a restaurant, bar or night club, from company site 152 via network 130 (step 202). In the exemplary embodiment, the reservation history includes the date/time of the reservation and the number of people associated with the reservation. In alternate embodiments, wait time program 112 may collect social media content or messages from social media server 140, which contain information relevant to past reservations or past visits made to the establishment by social media users. For example, for a restaurant named “Blue Plate”, wait time program 112 may collect social media messages that contain keywords such as “reservation”, “plans”, and “Blue Plate”. In addition, in this alternate embodiment, wait time program 112 analyzes the content of each collected social media message to determine the number of people associated with the message and analyzes the time stamp of each social media message, which is typically found in the metadata of the message, to determine the date and time of the reservation. For example, certain social media platforms allow users to “tag” other social media users who are accompanying them to an activity or an event. In this alternate embodiment, wait time program 112 may utilize this information to determine the number of people associated with the message. In addition, wait time program 112 may record the name of the social media users associated with each social media message, whether they are the source of the message or have been “tagged” in the message, so a user that appears in two separate collected social media messages does not get counted twice.

Wait time program 112 then retrieves wait time history for the establishment from company site 152 via network 130 (step 204). In the exemplary embodiment, the wait time history includes the average amount of time that each party of guests had to wait during each specific time block. In the exemplary embodiment, a time block is a period of three hours, however, in other embodiments, a time block may be another period of time. For example, the wait time history may recite that each party of guests had to wait for an average of 10 minutes during the 2 PM to 5 PM Wednesday time block, while each party of guests had to wait for an average of 15 minutes during the 5 PM to 8 PM Wednesday time block. In addition, in the exemplary embodiment, each week is broken down into fifty-six, three hour time blocks. Therefore, time block one of week one starts at 12 AM on Sunday and ends at 3 AM Sunday. Once the week is over, the numbering of the time blocks restarts with time block one of week two starting at 12 AM on the following Sunday. In addition, in the exemplary embodiment, wait time history also includes the number of guests that were served by the establishment during each time block. In the exemplary embodiment, a guest is served as soon as the guest is seated and therefore, a guest counts for the appropriate time block based on the time the guest was seated. It is important to note that the information regarding the number of guests served takes into account, not only the guests who made reservations, but also guests who did not. In alternate embodiments, the number of guests that were served by the establishment during each time block may be determined by collecting social media content or messages from social media server 140 which contain information relevant to past reservations or past visits made to the establishment by social media users, as described above.

Wait time program 112 then creates wait time model 114 for the establishment by correlating the retrieved reservation history and the retrieved wait time history with specific time blocks (step 206). In the exemplary embodiment, wait time program 112 analyzes the time/date information associated with each reservation to place each reservation into a specific time block. Wait time program 112 also correlates the number of guests served and the average amount of wait time experienced by each party of guests with each specific time block. Therefore, for each specific time block, wait time model 114 includes information stating the number of reservations made for the time block, the number of guests served during the time block, and the average wait time history experienced by each party of guests during the time block. In the exemplary embodiment, wait time model 114 contains at least two months worth of time blocks, i.e., 448 time blocks, however, in other embodiments, wait time model 114 may contain a different number of time blocks. In addition, wait time model 114 continuously updates so that wait time model 114 contains the most recent information.

Wait time program 112 then receives a request for a wait time estimate for the establishment for a specific time from computing device 120 via network 130 (step 208). In the exemplary embodiment, the user of computing device 120 inputs the request into wait time application 122 via user interface 124. The request is then transmitted by computing device 120 to wait time program 112 via network 130. Wait time program 112 then determines the relevant time block from the time indicated on the request. In other embodiments, the user of computing device 120 inputs a request for a wait time estimate for a specific time block rather than a specific time.

Wait time program 112 then collects social media content or messages containing information that indicates intent to visit the establishment during the specified time block (step 210). For example, as stated above, for a restaurant named “Blue Plate”, wait time program 112 may collect social media messages that contain keywords such as “reservation”, “plans”, and “Blue Plate”. Wait time program 112 then analyzes the content of each collected social media message to determine if each message falls within the specified time block. In the exemplary embodiment, wait time program 112 analyzes the time stamp associated with the message along with the content of the message to determine the associated time block of the social media message. For example, if the message states: “Going to dinner at Blue Plate tonight”, with the time stamp of the message reciting May 14^{th}, wait time program 112 may determine that the time block associated with the message is 6 PM to 9 PM on May 14^{th}, operating under the assumption that keywords such as “dinner” and “tonight” indicate the 6 PM to 9 PM time block. In the exemplary embodiment, wait time program 112 stores the social media messages that contain information indicating intent to visit the establishment during the specified time block.

Wait time program 112 then determines an estimated number of people that intend to visit the establishment during the specific time block by analyzing the content of each stored social media message to determine the number of people associated with each message (step 212). As stated above, certain social media platforms allow users to “tag” other social media users who are accompanying them to an activity or an event. In the exemplary embodiment, wait time program 112 analyzes this information to determine the number of people associated with the message. In addition, wait time program 112 records the name of the social media users associated with each social media message, whether they are the source of the message or have been “tagged” in the message, and continuously compares with names of social media users associated with other collected social media messages so a user that appears in two separate collected social media messages does not get counted twice.

Wait time program 112 then determines an estimated wait time for the establishment by comparing the determined estimated number of people to wait time model 114 (step 214). In the exemplary embodiment, wait time program 112 compares the estimated number of people determined for the specified time block to the counterpart time blocks from wait time model 114. For example, if the time specified in the user request received by wait time program 112 is Sunday at 6 PM, wait time program 112 determines the relevant time block is time block six (because the numbering of the time blocks begins at 12 AM on Sunday and each time block is a three-hour time period). Wait time program 112 then compares the estimated number of people determined for the time block to each time block six in wait time model 114. For example, if wait time model 114 contains information for a two-month time period, there would be eight of each type of time block because there are eight weeks in two months with each week containing a time block one through time block 56. Wait time program 112 compares the estimated number of people determined for the time block of the request to each time block to determine the counterpart time block or time blocks that has an associated number of guests served that most closely matches the estimate number of people determined for the time block of the request. For example, if the estimated number of people determined for the time block of the request is 50 and wait time model 114 includes four counterpart time blocks which have 45, 55, 30 and 25 guests respectively, wait time program 112 determines that the first two counterpart time blocks most closely match the estimated number of people. Therefore, wait time program 112 identifies the average wait time associated with each of the first two counterpart time blocks and averages the two identified wait times to yield the estimated wait time for the specified time block associated with the request received from computing device 120. In other embodiments, wait time program 112 may determine the counterpart time blocks which have an associated number of guests that are within a certain percentage of the estimated number of people determined by wait time program 112. Wait time program 112 then averages the average wait times associated with each counterpart time block which have an associated number of guests that are within the certain percentage of the estimated number of people to yield the estimated wait time for the specified time block associated with the request received from computing device 120. In this other embodiment, the certain percentage is 10%, but in other embodiments, the certain percentage may be another value. In further embodiments, wait time program 112 may examine all time blocks of wait time model 114, not only counterpart time blocks, to determine the time blocks which have an associated number of guests that are within a certain percentage of the estimated number of people determined by wait time program 112 for the specific time block associated with the request received from computing device 120.

In addition, wait time program 112 may also determine if a reservation is recommended for the specific time block associated with the request received from computing device 120. In the exemplary embodiment, once wait time program 112 determines the counterpart time block or time blocks of wait time model 114 which have a number of guests served which most closely matches the estimated number of guests associated with the request, wait time program 112 compares the number of reservations associated with the matching counterpart time block against a first threshold value. If there is more than one matching counterpart time block, wait time program 112 averages the number of reservations associated with each counterpart time block together to obtain an average number of reservations which is then compared to the first threshold value. If wait time program 112 determines that the number of reservations associated with the counterpart time block or time blocks exceeds the first threshold value, wait time program 112 determines that a reservation is recommended. If wait time program 112 determines that the number of reservations associated with the counterpart time block or time blocks does not exceed the first threshold value, wait time program 112 determines that a reservation is not recommended. In the exemplary embodiment, the first threshold value is 100, however, in other embodiments; the first threshold value may be a different number dependent on the seating capacity of the establishment.

Wait time program 112 then transmits the determined estimated wait time to wait time application 122 via network 130, and it is displayed to the user via user interface 124 (step 302). In addition, in the exemplary embodiment, wait time program 112 also transmits information regarding whether a reservation is recommended or not to wait time application 122 via network 130.

Wait time program 112 then determines if the determined estimated wait time exceeds a threshold wait time value (decision 304). In the exemplary embodiment, the threshold wait time value is forty-five minutes, however, in other embodiments, the threshold wait time value may be another value. If wait time program 112 determines that the estimated wait time does not exceed the threshold wait time value (decision 304. “NO” branch), then the estimated wait time is deemed acceptable. If wait time program 112 determines that the estimated wait time does exceed the threshold wait time value (decision 304, “YES” branch), wait time program 112 determines the estimated wait time for nearby and/or similar establishments by way of the same method discussed above (step 306). In the exemplary embodiment, for a restaurant, a similar establishment may be another restaurant serving the same type of cuisine. Wait time program 112 creates a wait time model for a similar or nearby establishment as discussed above. Wait time program 112 then collects social media content and determines an estimated number of people that intend to visit the establishment during the time specified in the user request. Wait time program then determines an estimated wait time for the establishment via comparison to the wait time model and transmits the estimated wait time for the similar or nearby establishment to wait time application 122 via network 130 (step 308).

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

FIG. 4 depicts a block diagram of components of server 110, computing device 120, social media server 140 and company server 150 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server 110, computing device 120, social media server 140 and company server 150 include communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

The programs wait time program 112 and wait time model 114 in server 110; programs wait time application 122 and user interface 124 in computing device 120; social media site 142 in social media server 140; and programs company site 152 in company server 150 are stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links. The programs, wait time program 112 and wait time model 114 in server 110; programs wait time application 122 and user interface 124 in computing device 120; social media site 142 in social media server 140; and programs company site 152 in company server 150 may be downloaded to persistent storage 408 through communications unit 412.

I/O interface(s) 414 allows for input and output of data with other devices that may be connected to server 110, computing device 120, social media server 140 and company server 150. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention, e.g., the programs, wait time program 112 and wait time model 114 in server 110; programs wait time application 122 and user interface 124 in computing device 120; social media site 142 in social media server 140; and programs company site 152 in company server 150, can be stored on such portable computer-readable storage media and can be loaded onto persistent storage 408 via I/O interface(s) 414. I/O interface(s) 414 can also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining a resource reservation wait time, comprising the steps of:
a first computer collecting resource reservation history for a first resource for a plurality of reservation time blocks;
the first computer collecting resource reservation wait time history for the first resource for each reservation time block of the plurality of reservation time blocks;
the first computer determining a number of patrons that utilized the first resource during each reservation time block of the plurality of reservation time blocks based on one or more of the resource reservation wait time history and the resource reservation history for the first resource;
the first computer creating a first resource reservation wait time model by correlating the number of patrons that utilized the first resource with the resource reservation wait time history for the first resource collected for the plurality of reservation time blocks;
the first computer receiving a request for a first resource reservation wait time estimate for a first reservation time block from a first user;
the first computer collecting a first plurality of social media content, wherein each member of the first plurality of social media content includes information indicating an intent to utilize the first resource during the first reservation time block;
the first computer determining an estimated number of patrons that intend to utilize the first resource during the first reservation time block based on at least the first plurality of social media content; and
the first computer determining a first estimated wait time for the first reservation time block by comparing at least the estimated number of patrons that intend to utilize the first resource during the first reservation time block to the first resource reservation wait time model.

2. The method of claim 1, further comprising the step of the first computer displaying the first estimated wait time to the first user.

3. The method of claim 1, further comprising the steps of:
the first computer determining an estimated number of reservations for the first reservation time block by comparing at least the estimated number of patrons that intend to utilize the first resource during the first reservation time block to the first resource reservation wait time model;
the first computer determining that the estimated number of reservations for the first reservation time block exceeds a first threshold value; and
the first computer determining that a reservation is recommended for the first reservation time block.

4. The method of claim 1, further comprising the steps of:
the first computer collecting resource reservation information for the first resource for the first reservation time block; and
the first computer determining an estimated number of patrons that intend to utilize the first resource during the first reservation time block based on at least the collected resource reservation information for the first resource and the first plurality of social media content.

5. The method of claim 1, further comprising the steps of:
the first computer determining the first estimated wait time for the first reservation time block for the first resource exceeds a second threshold value;
the first computer collecting a second plurality of social media content, wherein each member of the second plurality of social media content includes information indicating an intent to utilize the first resource during a second reservation time block;
the first computer determining an estimated number of patrons that intend to utilize the first resource during the second reservation time block based on at least the second plurality of social media content; and
the first computer determining a second estimated wait time for the second reservation time block by comparing at least the estimated number of patrons that intend to utilize the first resource during the second reservation time block to the first resource reservation wait time model.

6. The method of claim 1, further comprising the steps of:
the first computer determining the first estimated wait time for the first reservation time block for the first resource exceeds a second threshold value;
the first computer collecting resource reservation history for a second resource for the plurality of reservation time blocks;
the first computer collecting resource reservation wait time history for the second resource for each reservation time block of the plurality of reservation time blocks;
the first computer determining a number of patrons that utilized the second resource during each reservation time block of the plurality of reservation time blocks based on one or more of the resource reservation wait time history and the resource reservation history for the second resource;
the first computer creating a second resource reservation wait time model by correlating the number of patrons that utilized the second resource with the resource reservation wait time for the second resource collected for the plurality of reservation time blocks;
the first computer collecting a third plurality of social media content, wherein each member of the third plurality of social media content includes information indicating an intent to utilize the second resource during the first reservation time block;
the first computer determining an estimated number of patrons that intend to utilize the second resource during the first reservation time block based on at least the third plurality of social media content; and
the first computer determining a third estimated wait time for the first reservation time block by comparing at least the estimated number of patrons that intend to utilize the second resource during the first reservation time block to the second resource reservation wait time model.

7. The method of claim 5, further comprising the steps of:
the first computer determining that the second estimated wait time does not exceed the threshold value; and
the first computer displaying the second estimated wait time to the first user.

8. A computer program product for determining a resource reservation wait time, the computer program product comprising:
one or more computer-readable storage devices and program instructions stored on at least one of the one or more tangible storage devices, the program instructions comprising:
program instructions to collect resource reservation history for a first resource for a plurality of reservation time blocks;
program instructions to collect resource reservation wait time history for the first resource for each reservation time block of the plurality of reservation time blocks;
program instructions to determine a number of patrons that utilized the first resource during each reservation time block of the plurality of reservation time blocks based on one or more of the resource reservation wait time history and the resource reservation history for the first resource;
program instructions to create a first resource reservation wait time model by correlating the number of patrons that utilized the first resource with the resource reservation wait time history for the first resource collected for the plurality of reservation time blocks;
program instructions to receive a request for a first resource reservation wait time estimate for a first reservation time block from a first user;
program instructions to collect a first plurality of social media content, wherein each member of the first plurality of social media content includes information indicating an intent to utilize the first resource during the first reservation time block;
program instructions to determine an estimated number of patrons that intend to utilize the first resource during the first reservation time block based on at least the first plurality of social media content; and
program instructions to determine a first estimated wait time for the first reservation time block by comparing at least the estimated number of patrons that intend to utilize the first resource during the first reservation time block to the first resource reservation wait time model.

9. The computer program product of claim 8, further comprising program instructions to display the first estimated wait time to the first user.

10. The computer program product of claim 8, further comprising:
program instructions to determine an estimated number of reservations for the first reservation time block by comparing at least the estimated number of patrons that intend to utilize the first resource during the first reservation time block to the first resource reservation wait time model;
program instructions to determine that the estimated number of reservations for the first reservation time block exceeds a first threshold value; and
program instructions to determine that a reservation is recommended for the first reservation time block.

11. The computer program product of claim 8, further comprising:
program instructions to collect resource reservation information for the first resource for the first reservation time block; and
program instructions to determine an estimated number of patrons that intend to utilize the first resource during the first reservation time block based on at least the collected resource reservation information for the first resource and the first plurality of social media content.

12. The computer program product of claim 8, further comprising:
program instructions to determine the first estimated wait time for the first reservation time block for the first resource exceeds a second threshold value;
program instructions to collect a second plurality of social media content, wherein each member of the second plurality of social media content includes information indicating an intent to utilize the first resource during a second reservation time block;
program instructions to determine an estimated number of patrons that intend to utilize the first resource during the second reservation time block based on at least the second plurality of social media content; and
program instructions to determine a second estimated wait time for the second reservation time block by comparing at least the estimated number of patrons that intend to utilize the first resource during the second reservation time block to the first resource reservation wait time model.

13. The computer program product of claim 8, further comprising:
program instructions to determine the first estimated wait time for the first reservation time block for the first resource exceeds a second threshold value;
program instructions to collect resource reservation history for a second resource for the plurality of reservation time blocks;
program instructions to collect resource reservation wait time history for the second resource for each reservation time block of the plurality of reservation time blocks;
program instructions to determine a number of patrons that utilized the second resource during each reservation time block of the plurality of reservation time blocks based on one or more of the resource reservation wait time history and the resource reservation history for the second resource;
program instructions to create a second resource reservation wait time model by correlating the number of patrons that utilized the second resource with the resource reservation wait time for the second resource collected for the plurality of reservation time blocks;
program instructions to collect a third plurality of social media content, wherein each member of the third plurality of social media content includes information indicating an intent to utilize the second resource during the first reservation time block;
program instructions to determine an estimated number of patrons that intend to utilize the second resource during the first reservation time block based on at least the third plurality of social media content; and
program instructions to determine a third estimated wait time for the first reservation time block by comparing at least the estimated number of patrons that intend to utilize the second resource during the first reservation time block to the second resource reservation wait time model.

14. The computer program product of claim 12, further comprising:
the first computer determining that the second estimated wait time does not exceed the threshold value; and
the first computer displaying the second estimated wait time to the first user.

15. A computer system for determining a resource reservation wait time, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to collect resource reservation history for a first resource for a plurality of reservation time blocks;
program instructions to collect resource reservation wait time history for the first resource for each reservation time block of the plurality of reservation time blocks;
program instructions to determine a number of patrons that utilized the first resource during each reservation time block of the plurality of reservation time blocks based on one or more of the resource reservation wait time history and the resource reservation history for the first resource;
program instructions to create a first resource reservation wait time model by correlating the number of patrons that utilized the first resource with the resource reservation wait time history for the first resource collected for the plurality of reservation time blocks;
program instructions to receive a request for a first resource reservation wait time estimate for a first reservation time block from a first user;
program instructions to collect a first plurality of social media content, wherein each member of the first plurality of social media content includes information indicating an intent to utilize the first resource during the first reservation time block;
program instructions to determine an estimated number of patrons that intend to utilize the first resource during the first reservation time block based on at least the first plurality of social media content; and
program instructions to determine a first estimated wait time for the first reservation time block by comparing at least the estimated number of patrons that intend to utilize the first resource during the first reservation time block to the first resource reservation wait time model.

16. The computer system of claim 15, further comprising:
program instructions to determine an estimated number of reservations for the first reservation time block by comparing at least the estimated number of patrons that intend to utilize the first resource during the first reservation time block to the first resource reservation wait time model;
program instructions to determine that the estimated number of reservations for the first reservation time block exceeds a first threshold value; and
program instructions to determine that a reservation is recommended for the first reservation time block.

17. The computer system of claim 15, further comprising:
program instructions to collect resource reservation information for the first resource for the first reservation time block; and
program instructions to determine an estimated number of patrons that intend to utilize the first resource during the first reservation time block based on at least the collected resource reservation information for the first resource and the first plurality of social media content.

18. The computer system of claim 15, further comprising:
program instructions to determine the first estimated wait time for the first reservation time block for the first resource exceeds a second threshold value;
program instructions to collect a second plurality of social media content, wherein each member of the second plurality of social media content includes information indicating an intent to utilize the first resource during a second reservation time block;
program instructions to determine an estimated number of patrons that intend to utilize the first resource during the second reservation time block based on at least the second plurality of social media content; and
program instructions to determine a second estimated wait time for the second reservation time block by comparing at least the estimated number of patrons that intend to utilize the first resource during the second reservation time block to the first resource reservation wait time model.

19. The computer system of claim 15, further comprising:
program instructions to determine the first estimated wait time for the first reservation time block for the first resource exceeds a second threshold value;
program instructions to collect resource reservation history for a second resource for the plurality of reservation time blocks;
program instructions to collect resource reservation wait time history for the second resource for each reservation time block of the plurality of reservation time blocks;
program instructions to determine a number of patrons that utilized the second resource during each reservation time block of the plurality of reservation time blocks based on one or more of the resource reservation wait time history and the resource reservation history for the second resource;
program instructions to create a second resource reservation wait time model by correlating the number of patrons that utilized the second resource with the resource reservation wait time for the second resource collected for the plurality of reservation time blocks;
program instructions to collect a third plurality of social media content, wherein each member of the third plurality of social media content includes information indicating an intent to utilize the second resource during the first reservation time block;
program instructions to determine an estimated number of patrons that intend to utilize the second resource during the first reservation time block based on at least the third plurality of social media content; and
program instructions to determine a third estimated wait time for the first reservation time block by comparing at least the estimated number of patrons that intend to utilize the second resource during the first reservation time block to the second resource reservation wait time model.

20. The computer system of claim 18, further comprising the steps of:
the first computer determining that the second estimated wait time does not exceed the threshold value; and
the first computer displaying the second estimated wait time to the first user.
